(19) United States
(12) Patent Application Publication
(10) Pub. No.: US 2026/0056984 A1
(43) Pub. Date: Feb. 26, 2026

(54) Techniques for Improved Prompt Engineering

(71) Applicant: SUREPATH AI, INC., Denver, CO (US)

(72) Inventors: Casey Bleeker, Denver, CO (US); Randall Birdsall, Laurel, MD (US)

(21) Appl. No.: 18/810,199

(22) Filed: Aug. 20, 2024

(51) Int. Cl. G06F 16/332; G06F 40/279

(52) U.S. Cl. CPC G06F 16/3329; G06F 40/279

(57) ABSTRACT

Techniques for improved prompt engineering are disclosed herein. An example computer-implemented method includes receiving an initial input from a user; determining an intent corresponding to the initial input; providing a set of input requests to the user based on the intent or the initial input; receiving one or more subsequent inputs from the user in response to the set of input requests; applying a prompt generation engine to (i) the intent, (ii) the initial input, and (iii) the one or more subsequent inputs to output an input prompt; transmitting the input prompt to a machine learning model that is configured to output a response to the input prompt; and causing the response to be displayed for viewing by the user.

### TECHNICAL FIELD

The present disclosure generally relates to prompt engineering techniques, and more particularly, to the determination of well-informed, comprehensive input prompts for use by machine learning models to output similarly comprehensive responses.

### BACKGROUND

With the rapid advancements in generative AI technology, an increasing number of users are utilizing these systems for various tasks, such as generating resumes, creating business proposals, etc. Conventional generative AI models typically produce outputs with a degree of granularity that corresponds to the granularity of the input and/or have strict prompt structure requirements.

However, conventional techniques generally offer little to no guidance or assistance to aid users in satisfying these requirements. Many users thereby struggle to structure their queries and information in a manner that the AI can accurately interpret and utilize, leading to unsatisfactory outputs. For example, an AI generated resume using conventional techniques may lack one or more relevant sections (e.g., work experience) if the input prompt did not include that information or any indication that the relevant sections should be included. As another example, a user may provide an input prompt completely lacking the necessary information for a generative AI model to generate a high-quality proposal, and conventional techniques typically lack the capability to retrieve, access, and/or otherwise supplement/enrich the user's input prompt with the necessary information.

Thus, to address these and other challenges, improved prompt engineering techniques are necessary.

### SUMMARY

In some aspects, the techniques described herein relate to a computer-implemented method for improved prompt engineering, including: receiving, by one or more processors, an initial input from a user; determining, by the one or more processors, an intent corresponding to the initial input; providing, by the one or more processors, a set of input requests to the user based on the intent or the initial input; receiving, by the one or more processors, one or more subsequent inputs from the user in response to the set of input requests; applying, by the one or more processors, a prompt generation engine to (i) the intent, (ii) the initial input, and (iii) the one or more subsequent inputs to output an input prompt; transmitting, by the one or more processors, the input prompt to a machine learning model that is configured to output a response to the input prompt; and causing, by the one or more processors, the response to be displayed for viewing by the user.

In some aspects, the techniques described herein relate to a computer system for improving prompt engineering including: one or more processors; and a non-transitory program memory coupled to the one or more processors and storing executable instructions that, when executed by the one or more processors, causes the computer system to: receive an initial input from a user; determine an intent corresponding to the initial input; provide a set of input requests to the user based on the intent or the initial input; receive one or more subsequent inputs from the user in response to the set of input requests; apply a prompt generation engine to (i) the intent, (ii) the initial input, and (iii) the one or more subsequent inputs to output an input prompt; transmit the input prompt to a machine learning model that is configured to output a response to the input prompt; and cause the response to be displayed for viewing by the user.

In some aspects, the techniques described herein relate to a tangible, non-transitory computer-readable medium storing executable instructions for improving prompt engineering, the instructions, when executed by one or more processors of a computer system, cause the computer system to: receive an initial input from a user; determine an intent corresponding to the initial input; provide a set of input requests to the user based on the intent or the initial input; receive one or more subsequent inputs from the user in response to the set of input requests; apply a prompt generation engine to (i) the intent, (ii) the initial input, and (iii) the one or more subsequent inputs to output an input prompt; transmit the input prompt to a machine learning model that is configured to output a response to the input prompt; and cause the response to be displayed for viewing by the user.

### BRIEF DESCRIPTION OF THE DRAWINGS

The Figures described below depict preferred embodiments for purposes of illustration only. One skilled in the art will readily recognize from the following discussion that alternative embodiments of the systems and methods illustrated herein may be employed without departing from the principles of the disclosure described herein.

FIG. 1A is a block diagram of an enterprise data management and monitoring system, in accordance with various aspects of the present disclosure.

FIG. 1B is a block diagram showing additional details of the enterprise data management and monitoring system of FIG. 1A, in accordance with various aspects of the present disclosure.

FIG. 1C is a block diagram of a prompt engineering engine, in accordance with various aspects of the present disclosure.

FIG. 2 depicts a flow diagram of a prompt engineering session, in accordance with various aspects of the present disclosure.

FIG. 3 depicts a block diagram of context relevancy levels of context data, in accordance with various aspects of the present disclosure.

FIG. 4 depicts a first graphical user interface (GUI), in accordance with various aspects of the present disclosure.

FIG. 5 depicts a second GUI featuring a set of input requests, in accordance with various aspects of the present disclosure.

FIG. 6 depicts a user activity diagnostics report, in accordance with various aspects of the present disclosure.

FIG. 7 illustrates a computer-implemented method for improved prompt engineering, in accordance with various aspects of the present disclosure.

### DETAILED DESCRIPTION

Broadly speaking, the techniques of the present disclosure relate to improved prompt engineering systems and methods that receive an initial input from a user, provide a set of input requests to the user, and use subsequent inputs from the user to output an input prompt for a machine learning model. In this manner, the techniques of the present disclosure output data-rich input prompts that improve the quality of responses output by the machine learning model. These techniques therefore improve over conventional techniques at least by significantly improving the accuracy and effectiveness of machine learning models configured to provide responses to user requests.

As previously mentioned, conventional techniques do not assist or otherwise facilitate users structuring their queries or information in ways a machine learning model can accurately interpret and utilize. These conventional techniques therefore experience significant issues, such as low-quality, non-comprehensive prompts leading to unsatisfactory responses from the machine learning model. For example, when a user prompts a machine learning model to generate a resume using conventional techniques, the machine learning model will generate a resume based only on data included in the user's initial request. However, user requests frequently lack sufficient and/or critical information, and/or are often structured in a way (e.g., ambiguous) that is difficult for machine learning models to interpret.

By contrast, the techniques of the present disclosure overcome these challenges of conventional techniques, and thereby provide multiple technical advantages over such conventional techniques. For example, providing additional input requests to a user and applying a prompt generation engine to generate an input prompt based on the user's initial input and subsequent inputs, as described herein, overcomes the challenges associated with low-quality, non-comprehensive prompts leading to unsatisfactory responses from a machine learning model, as experienced by conventional techniques. By applying the prompt generation engine to a user' initial input, intent, and subsequent inputs, the resulting input prompt output by the prompt generation engine is significantly more data-rich and thorough than the user's initial input. Consequently, responses output by the machine learning model based on such input prompts are significantly more comprehensive, tailored, and generally higher quality than was previously achievable using conventional techniques.

Moreover, the techniques of the present disclosure may provide a user with a set of input requests based on the user's intent associated with the initial input to further alleviate the issues experienced by conventional techniques. When the set of input requests is based on a user's intent, each input request included therein (i.e., as part of the set of input requests) more acutely guides the user to provide subsequent inputs that will accurately orient the machine learning model to produce output(s) that achieve/satisfy the user's intent. The intent of an initial input, as described further herein, can be intention classifications of the initial input. For example, if the initial input is “create a resume for a software engineer”, then the intents could be or include “software engineer” and/or “generate a resume”. In other words, the set of input requests are more personalized, goal-oriented, and comprehensive to meet the user's specific intent, resulting in correspondingly personalized, goal-oriented, and comprehensive input prompts and responses from the engines/models described herein. These aspects therefore improve over conventional techniques at least by improving the accuracy (e.g., due to increased personalization, goal-oriented focus, comprehensiveness) of such prompts and outputs in a manner that was previously unachievable using conventional techniques.

As another example, the present techniques overcome the inefficiencies stemming from forcing users to create an optimal and rigidly structured input without guidance. Using the present techniques, users are no longer tasked with initially providing all necessary inputs to receive a meaningful output. Instead, the techniques of the present disclosure intake initial user inputs and provide users with a set of input requests to guide them to input additional necessary or relevant information for generating a high quality, meaningful response. Additionally, the prompt generation engine of the present techniques automatically outputs a formatted input prompt based on the user's responses that enables a machine learning model to more efficiently read/interpret the input prompt, as the user's subsequent inputs are categorized within the set input requests.

The techniques of the present disclosure thus improve the functionality of a computing device (e.g., a hosting server such as a central server) at least by providing a set of input requests to receive subsequent inputs from a user that increase the accuracy, comprehensiveness, and personalization of input prompts/responses provided to and/or output by a machine learning model of the computing device. Compared to conventional techniques that utilize users' incomplete and disorganized initial inputs to generate a response, the present techniques intelligently enhance the user's initial inputs by providing pointed, relevant input requests based on the user's input or intent. The machine learning model(s) of the present disclosure then use the user's subsequent inputs, initial input, and intent to generate a response, which was not performed by conventional techniques. That is, the present disclosure describes improvements in the functioning of the computer itself because the computing device more efficiently and qualitatively generates responses to user inputs by leveraging subsequent inputs to input requests to create a highly accurate, comprehensive, and structured input prompt, as compared to the initial input. This therefore improves over the prior art at least because existing systems typically generate responses based on a user's initial input, and consequently lack the accurate and comprehensive input prompt generation of the present techniques.

Moreover, the present disclosure includes effecting a transformation or reduction of a particular article to a different state or thing, e.g., transforming a response to a machine learning model and reducing the processing demand of a computing system (and associated subsystems/components/devices) from a non-optimal or error state (e.g., generating a response using an initial input) to an optimal (or closer to optimal) state by utilizing subsequent inputs to the input request to generate a response, and consequently (1) reducing the processing demand conventionally required to generate a response by a machine learning model and (2) qualitatively improving the response.

Still further, the present disclosure includes specific features other than what is well-understood, routine, conventional activity in the field, or adding unconventional steps that demonstrate, in various embodiments, particular useful applications, e.g., providing, by the one or more processors, a set of input requests to the user based on the intent or the initial input; receiving, by the one or more processors, one or more subsequent inputs from the user in response to the set of input requests; and/or applying, by the one or more processors, a prompt generation engine to (i) the intent, (ii) the initial input, and (iii) the one or more subsequent inputs to output an input prompt, among others.

Moreover, in some embodiments, the techniques disclosed herein include creating input requests using an input request creation engine. In certain aspects, the input requests can be created by applying a machine learning model (e.g., LLM) to the initial input. In either case, the creation of input requests yields several notable improvements to conventional prompt engineering techniques. For example, by using either technique, the set of input requests are more tailored/reflective of the user's initial input and more comprehensive, which helps the user develop more personalized and comprehensive subsequent inputs in response to the set of input requests. By creating these sets of input requests in real-time, the techniques of the present disclosure increase the adaptability of the input prompt and response output solutions described herein. Namely, the input request creation engine is able to interpret the user's initial input and/or intent, determine what additional information is (1) relevant and important to fully/comprehensively detail the user's request and (2) not currently included or indicated by the user's initial input, and create sets of input requests that are most likely to illicit such additional information from the user. In so doing, the techniques of the present disclosure improve over conventional techniques by adaptively determining how to acquire any remaining necessary information from the user to enhance the user's experience in a manner that was not possible using conventional techniques.

Additionally, in some embodiments, the set of input requests are structured into a organized format that enables users to clearly identify requested information and provide subsequent relevant inputs. For example, the input request creation engine may generate a set of input requests in a questionnaire format that clearly identifies the requested information, and includes a separate text box corresponding to each question where users can provide subsequent input. This clear, succinct format prevents the prompt generation engine from being confused about which subsequent input corresponds to which question, and therefore from incorrectly using/attributing the subsequent inputs and/or hallucinating portions of a resulting input prompt. Consequently, such a structured format facilitates more effective and relevant input requests, subsequent inputs, and input prompts.

In certain aspects, the prompt generation engine may use context data to make the input prompt more accurate, tailored to the user, and comprehensive. The prompt generation engine uses different levels of context data until it reaches its context threshold, guaranteeing that the input prompt has enough information for the machine learning model to generate a comprehensive response. Additionally, the contextual cues and relevant information from previous interactions within the context data may enable the present disclosure to maintain coherence and continuity in the conversation.

In certain embodiments, the set of input requests comprises a shortcut accessible to the user that asks specific questions tailored to the user's initial input, such that the machine learning model uses the subsequent inputs (e.g., answers) to the specific questions to generate a high-quality response. The shortcuts reduce the input/output variability between the user and the prompt generation engine by eliminating the user's task of creating a relevant initial input, which is often misinterpreted and/or insufficiently descriptive of the user's request. For example, a user in a conventional system may submit an initial input to “create a resume” and receive a generic output including sections such as job title, education, experience, etc. However, the user may desire a resume tailored to a specific format, which may require additional sections such as a headshot, QR code to a website, etc. For such resumes, the input creation engine may create a shortcut with input requests seeking specific sections for inclusion and/or data associated therewith that conveniently requests all relevant data from the user. In this manner, the present techniques improve the user experience as compared to conventional techniques that provide no such shortcuts, and generally lack such user guidance capabilities.

In some embodiments, the set of input requests also includes context data of the user and/or a type of machine learning model. Generally speaking, necessary inputs to generate an optimal response for one machine learning model may be different than another machine learning model. To account for these differences, the set of input requests are tailored to the needs of the specific machine learning model, such as prompt formatting, types of subsequent inputs, etc. For example, one machine learning model may prefer input prompts separated into short, simple sentences while another machine learning model prefers input prompts in a long, paragraph-like format. In another example, one machine learning model may prefer numerical inputs and the systems described herein may therefore tailor the set of input requests to receive numerical answers. Consequently, each specific machine learning model available for use receives a highly tailored input prompt and thereby provides a comprehensive and accurate response. These techniques therefore provide a technical improvement over conventional techniques by incorporating context data and/or a type of machine learning model into a set of input requests that will cause the machine learning model to generate more optimal outputs than was conventionally possible.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art.

### Example Computing System

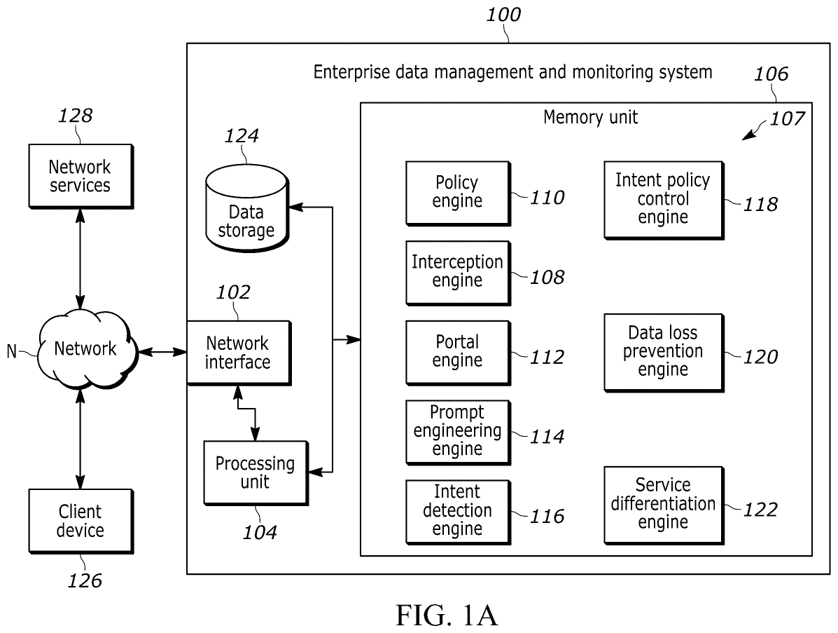

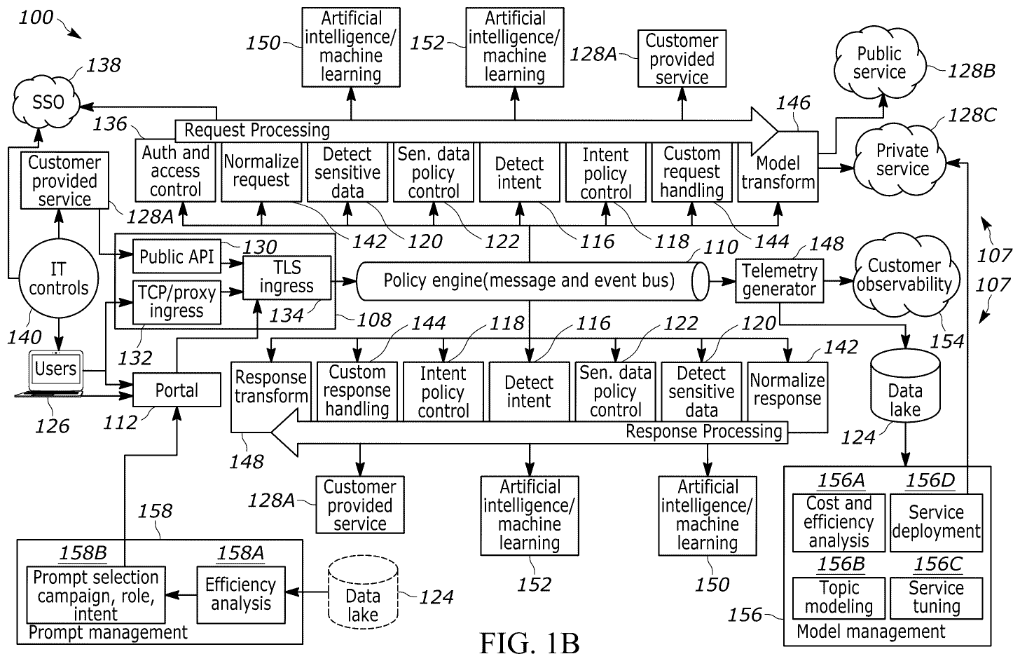

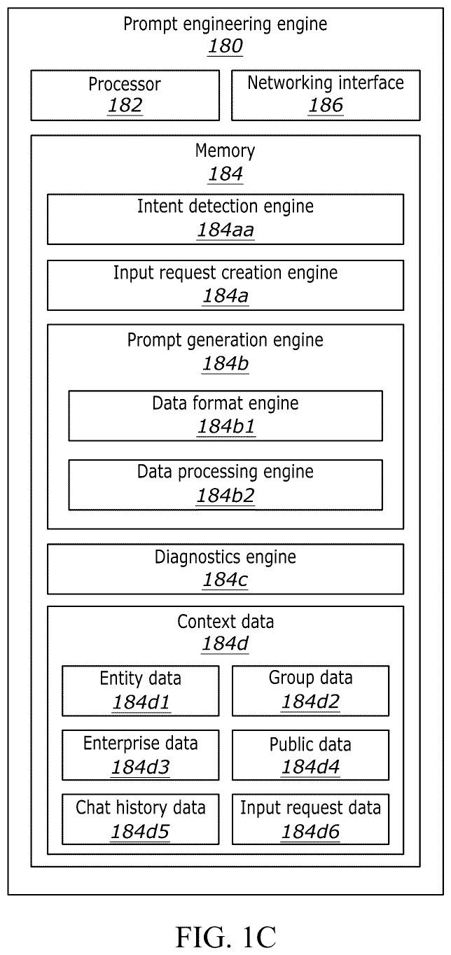

FIG. 1A is a block diagram of an enterprise data management and monitoring system 100. The system 100 includes a network communication interface 102 for communicating with a network N, a processing unit 104, and a memory unit 106. The network N may include various data transmission network topologies known in the art such as a local area network (LAN), a wide area network (WAN), combinations thereof, etc.

Processing unit 104 includes one or more processors, each of which may be a programmable microprocessor or the like that executes software instructions stored in memory unit 106 to execute some or all of the functions of the enterprise data management and monitoring system 100 as described herein. Processing unit 104 may include one or more graphics processing units (GPUs) and/or one or more central processing units (CPUs), for example. Alternatively, or in addition, one or more processors in processing unit 104 may be other types of processors (e.g., application-specific integrated circuits (ASICs), field-programmable gate arrays (FPGAs), etc.), and some of the functionality of the enterprise data management and monitoring system 100 as described herein may instead be implemented in hardware.

Memory unit 106 may include one or more volatile and/or non-volatile memories. Any suitable memory type or types may be included in memory unit 106, such as read-only memory (ROM) and/or random access memory (RAM), flash memory, a solid-state drive (SSD), a hard disk drive (HDD), and so on. Collectively, memory unit 106 may store one or more software applications, the data received/used by those applications, and the data output/generated by those applications.

In particular, memory unit 106 stores the software instructions of various engines 107 that, when executed by processing unit 104, perform various functions for the purpose managing and monitoring enterprise data being used and generated by enterprise associated client devices. As used herein “enterprise data” may include electronic documents, images, metadata, computer code, AI parameters, or other similar electronically readable data that is under the control of and/or generated by an enterprise. An “enterprise” as used herein is a company, corporation, or similar entity that employs the enterprise data management and monitoring system 100. Specifically, in the example embodiment of FIG. 1A, memory unit 106 includes an interception engine 108, a policy engine 110, a portal engine 112, a prompt engineering engine 114, an intent detection engine 116, an intent policy control engine 118, a data loss prevention engine 120, and a service differentiation engine 122. As shown in FIG. 1A the enterprise data management and monitoring system 100 can also include a data storage system 124. The data storage system 124 can be one or multiple elements that are a part or portion of the memory unit 106 and/or can be external devices accessible by the processing unit 104 via wired or wireless methods known in the art.

In general, the enterprise data management and monitoring system 100 is configured to manage, monitor, and/or modify the flow of data between a client device 126 and network services 128. The network services 128 may include services hosted by the enterprise that operates the enterprise data management and monitoring system 100 and/or externally hosted public or private network services as described herein. The network services 128 may be accessed via a web browser, dedicated mobile or desktop software application, operating system components, network hardware or software, etc. The enterprise data management and monitoring system 100 is configured to automatically conform an enterprise user intended interaction from the client device 126 with one of the network services 128 into a proper and approved use where possible by, for example, identifying and understanding the full context of the intended interaction. To facilitate this process, the interception engine 108 is configured to intercept outbound network traffic from the client device 126 to the network services 128 and inbound network traffic from the network services 128 back to the client device 126 via the network communication interface 102. The policy engine 110 and other ones of the various engines 107 are configured to perform various management and monitoring operations with respect to the inbound and outbound network traffic either directly or by using other ones of the various engines 107 as described herein. The various management and monitoring operations are described in more detail below, but in general include actions that control the interaction of the client device 126 with the network services 128, identify or generate data relevant for controlling the interaction, identify or generate data for retrospective analysis of the interaction, and/or identify or generate date for prospectively improving future interactions.

In some embodiments, the management of the inbound network traffic and the outbound network traffic is facilitated in part by the portal engine 112. In particular, the portal engine 112 may be configured to provide a graphical interface for display and interaction on the client device 126. The graphical interface can facilitate user input of the contents of the outbound network traffic and display the contents of the recipient specific data. The portal engine 112 may be configured to provide the graphical interface as a web page accessible through an internet browser on the client device, a window display of an application running locally on the client device, and/or other similar methods known in the art. The portal engine 112 may also be configured to enforce various security measures such as authenticating the client device 126 and providing authentication credentials to the network services 128 either individually or in conjunction with other engines of the enterprise data management and monitoring system 100. In some embodiments, the policy engine 110 and/or another one of the engines 107 of the enterprise data management and monitoring system 100 can be configured to direct the client device 126 to the web page, application, etc. facilitated by the portal engine 112 when the outbound network traffic is directed to one of the network services 128 in an unapproved manner. For example, the client device 126 can be redirected when the one of the network services 128 is not one of a set of approved network services stored in the data storage system 124, is being accessed with personal user credentials rather than enterprise level credentials, and/or when other preconfigured trigger conditions are met.

However, in some embodiments, the enterprise data management and monitoring system 100 may be configured to utilize an interface provided by one of the network services 128 to receive the outbound network traffic and display the recipient specific dataset to the client device 126. In these embodiments, the client device 126 is presented with an interface of one of the network services 128 or a different intended network service rather than the interface generated by the portal engine 112. In embodiments where the interface of an intended network service is displayed, the enterprise data management and monitoring system 100 can inject datasets generated from other ones of the network service 128 therein such that the data will appear to the user of the client device 126 to be results provided by the intended network service when in actuality the contents of the dataset are generated from a different one of the network services 128.

As shown in FIG. 1B, the enterprise data management and monitoring system 100 can include additional engines and sub engines of the various engines 107 that are configured to perform additional tasks as described in more detail herein.

These additional engines and sub engines can include a public application programming interface (API) 130, a TCP/Proxy Ingress 132, a TLS Ingress 134 that together make up the interception engine 108 and are together configured to direct outbound traffic from the client device 126 and inbound network traffic from the network services 128 to the policy engine 110. The public API 130 is like APIs known in the art and documents the specific manner mechanisms, etc., that external devices, software, etc. can use to interface with the enterprise data management and monitoring system 100. The TCP/Proxy Ingress 132 is configured to provide forward and reverse proxy functionality for the client device 126 and the TLS Ingress 134 is configured to provide a security layer for network traffic flowing into and out of the enterprise data management and monitoring system 100.

As shown in FIG. 1B, the network services 128 may include a variety of different services. These services include, but are not limited to, customer provided network services 128A, publicly available services 128B, and/or private services 128C. The publicly available services 128B may include pretrained AI models such as convolutional neural network (CNN) models, transformer models (large language models, large multi-modal models, etc.), recurrent/recursive neural network (RNN) models, sorting/clustering models, combinations thereof, etc. managed and controlled by third parties external to an enterprise with which the client device 126 is associated. In contrast, the private services 128C may include AI models of the various types described herein and known in the art that are under the control of the enterprise. Furthermore, the private services 128C may include AI models with parameter values trained using only data controlled or approved by the enterprise or may include variations of publicly available services 128B with parameter values that are further tuned or trained using the data controlled or approved by the enterprise. It should be appreciated that the network services 128 may include various non AI or ML related services that can pose a risk to enterprise data such as public email services, open source code repositories, business process tools, artifact and file sharing services, cloud computing services, social media platforms, financial services, backup services, e-commerce platforms, instant messaging, productivity and collaborative tools, etc.

In the configuration of the enterprise data management and monitoring system 100 shown in FIG. 1B, some of the various engines 107 are configured as sub-engines of the policy engine 110. The policy engine 110 may utilize the sub engines to perform the various management and monitoring operations of the enterprise data management and monitoring system 100 on both requests (e.g., outbound traffic from the client device 126) and responses (e.g., inbound network traffic from the network services 128).

The sub-engines of the policy engine 110 include the intent detection engine 116, the intent policy control engine 118, the data loss prevention engine 120, and the service differentiation engine 122 shown in FIG. 1A, which are described in more detail below. The sub-engines of the policy engine 110 can also include additional engines of the various engines 107. For example, an authentication and access control module 136 may be configured to manage respective log-in credentials for a set of approved ones of the network services 128 that are stored in the data storage system 124. The authentication and access control module 136 may interface with single-sign-on (SSO) systems 138 and other IT control systems 140 for accessing the network services 128 including the customer provided network services 128A, the publicly available services 128B, and the private services 128C.

The sub-engines of the policy engine 110 as shown in FIG. 1B also include a normalization engine 142, a custom request handling engine 144 for routing traffic to the customer provided network services 128A, and a transformation engine 146, and a telemetry generator 148. The custom request handling engine 144 is configured to route network traffic through the enterprise data management and monitoring system 100 into the customer provided network services 128A. In particular, the custom request handling engine 144 allows the user of the enterprise data management and monitoring system 100 to capture, trigger internal process from, modify, or stop further processing based on the user's own internal logic rules that the user may or may not want to share with the enterprise data management and monitoring system 100. The policy engine 110 may also include AI/ML models 150 and 152 utilized by the data loss prevention engine 120 and intent detection engine 116, respectively. The data loss prevention engine 120 is configured to check whether the user inputs and outputs include sensitive information pertaining to the enterprise. The data loss prevention engine 120 may also choose different actions to determine a course of action to take (e.g., BLOCK, REROUTE, ALLOW, etc.). The data loss prevention engine 120 may also be customized for different enterprises, as the sensitive information pertaining to each enterprise may be different.

The telemetry generator 148 generates metadata and other similar data elements that document operation of the enterprise data management and monitoring system 100 over time (e.g., details of what the enterprise data management and monitoring system 100 does, is asked to do, refrains from doing, etc.). The metadata and other similar data elements are saved in the data storage system 124 and can be accessed by approved users via an observation platform 154.

As shown in FIG. 1B, the data storage system 124 may comprise a data lake, which houses model management data/tool 156 relating to the private services 128C and prompt management data/tools 158.

The model management data/tool 156 includes a cost and efficacy analysis tool 156A, a topic modeling tool 156B, a service tuning tool 156C, and a service deployment tool 156D.

The cost and efficacy analysis tool 156A is configured to generate and output metrics relating to the cost and efficacy of the private services 128C. The topic modeling tool 156B is configured to identify patterns in data sets used in conjunction with the private services 128C. The service tuning tool 156C is configured to further train or tune the parameter values of the private services 128C (e.g., to initially tune versions AI model versions of the private services 128C based on the publicly available services 128B and/or to revise the services 128C in response to updated data). The service deployment tool 156D is configured to manage deployment of the private services 128C.

The prompt management data/tools 158 includes a prompt efficacy analysis tool 158A and a prompt selection tool 158B. The prompt efficacy analysis tool 158A is configured to provide data analysis of the suitability of AI/ML input prompts to achieve a specified goal. The prompt selection tool 158B is configured to assist a user of the client device 126 in selecting and/or generating better prompts for input into the publicly available services 128B and/or the private services 128C either alone or in conjunction with the prompt engineering engine 114 as described herein.

FIG. 1C is an expanded block diagram of a prompt engineering engine 180, in accordance with various aspects of the present disclosure. Generally speaking, the prompt engineering engine 180 receives an initial input from a user, provides a set of input requests to the user based on the initial input (e.g., asking a set of questions to receive more information), and determines an input prompt based on the initial input, an intent, and/or one or more subsequent inputs to the set of input requests. The prompt engineering engine 180 includes one or more processors 182, one or more memories 184, and a networking interface 186. The memories 184 include an intent detection engine 184aa, an input request creation engine 184a, a prompt generation engine 184b, a diagnostics engine 184c, and a set of context data 184d. The prompt generation engine 184b includes an data format engine 184b1 and a data processing engine 184b2. The context data 184d includes a set of entity data 184d1, a set of group data 184d2, a set of enterprise data 184d3, a set of public data 184d4, a set of chat history data 184d5, and a set of input request data 184d6. In certain embodiments, the intent detection engine 184aa may be separate from the prompt engineering engine 180, for example, as part of the intent policy control engine 118 depicted in FIG. 1A. Moreover, in some embodiments, the prompt engineering engine 180 may be the prompt engineering engine 114 of FIG. 1A.

When the prompt engineering engine 180 receives an initial input from a user, the prompt engineering engine 180 executes the prompt generation engine 184b to generate an input prompt. The prompt generation engine 184b generates an input prompt that a machine learning model can use to output a response. The prompt generation engine 184b may receive the intent, the initial input, and one or more subsequent inputs. The one or more subsequent inputs from the user may be inputs the user has provided based on the set of input requests. The prompt generation engine 184b enriches the input prompt by using the one or more subsequent inputs to the set of input requests. This enables the prompt generation engine 184b to generate data-rich input prompts that improve the quality of responses output by the machine learning model. Once generated, the prompt generation engine 184b may transmit the input prompt to a machine learning model, which may be from an approved service of a set of approved services.

In certain embodiments, the prompt generation engine 184b may additionally use the context data 184d to generate the input prompt. The context data 184d is data that can be used by the prompt generation engine 184b to generate data-rich input prompts, and generally represents data at different levels of scope and/or relevancy. The context data generally includes entity data 184d1, group data 184d2, enterprise data 184d3, and public data 184d4, which are grouped into multiple context relevancy levels. The entity data 184d1 may be the most relevant (i.e., narrowest), the group data 184d2 may be the second most relevant and broader in scope than the entity data 184d1, the enterprise data 184d3 may be the third most relevant and broader in scope than the entity data 184d1 and the group data 184d2, and the public data 184d4 may be the least relevant and broader in scope than the entity data 184d1, the group data 184d2, and the enterprise data 184d3. When the prompt generation engine 184b utilizes the context data 184d to generate an input prompt, the prompt generation engine 184b can generate data-rich input prompts that are not limited to the initial input and the one or more subsequent inputs.

The prompt generation engine 184b may be structured such that the amount of context data satisfies a context threshold. The context threshold is generally a threshold used by the prompt generation engine 184b to ensure that the prompt generation engine 184b has sufficient data to generate data-rich input prompts. The context threshold can be defined in several ways, such as but not limited to, a minimum number of sentences or word counts in an input prompt, a minimum vector similarity score (e.g., cosine similarity score) through vector embeddings to ensure that the context aligns with the input prompt, and/or a minimum relevancy score (e.g., named entity recognition score) to ensure relevant entities/information exist in the input prompt. An example of a context threshold for a prompt generation engine could involve requiring the input prompt to contain at least 50 words to ensure sufficient detail, achieving a cosine similarity score of at least 0.85 between the input prompt and the context data to ensure high alignment, and/or obtaining a named entity recognition score of at least 0.90 to ensure relevant information exists in the input prompt. In some embodiments, the prompt generation engine 184b may apply a natural language processing technique on the context data to remove common stop words to arrive at semantically meaningful words, and proceed to make sure that the context data satisfies the context threshold (e.g., minimum word count). If the user provides extensive subsequent inputs, the context data that is necessary to meet the context threshold may be small. Thus, by satisfying the context threshold, the prompt generation engine 184b guarantees that the input prompt has enough information for the machine learning model to generate a comprehensive response. To do this, the prompt generation engine 184b always initially evaluates a context relevancy level that is most relevant (i.e., narrow) to the user, and progressively evaluates broader context relevancy levels until the context threshold is met. For example, the prompt generation engine 184b may determine that data included within a first context relevancy level (e.g., an entity level) fails to satisfy the context threshold. In this instance, the prompt generation engine 184b may incorporate additional context data 184d by adjusting from the first context relevancy level to a second, broader context relevancy level (e.g., a group level).

In some embodiments, instead of iteratively progressing through each individual context relevancy level, the prompt generation engine 184b may determine that extensive context relevancy level broadening is required to meet the context threshold and may skip one or more context relevancy levels. For example, the prompt generation engine 184b may skip from the first context relevancy level (e.g., the entity level) to a fourth context level (e.g., a public level). In some other embodiments, the prompt generation engine 184b may ask a machine learning model of an approved service what additional context in the input prompt would make the machine learning model give a high-quality response. Based on the feedback the prompt generation engine 184b receives from the machine learning model, the prompt generation engine 184b can search through the context data to find the additional context that would make the machine learning model give a high-quality response and use the additional context to determine a data-rich input prompt.

In certain embodiments, the prompt generation engine 184b may use the data format engine 184b1 and the data processing engine 184b2 when generating the input prompt. The data format engine 184b1 generally formats the input prompt into a mode specific format (e.g., a respective API schema) required by an approved service. The data processing engine 184b2 generally formats the input prompt to a data processing schema required by an approved service. The data processing schema may represent an input prompt format that a machine learning model of an approved service prefers to generate an optimal response. For example, one machine learning model may prefer the input prompt formatted in short, separate sentences, prompting the data processing engine 184b2 to divide paragraphs into short sentences. Another machine learning model may prefer the input prompt formatted in numerical inputs, prompting the data processing engine 184b2 to transform texts into numerical features.

Each approved service of the plurality of approved services may comprise, for example, a respective machine learning model, a respective API schema indicating a respective input prompt type, and/or a data processing schema indicating a respective input prompt format. The prompt generation engine 184b uses the data format engine 184b1 to format the respective input prompt type required for the approved service (e.g., an API schema). The prompt generation engine 184b uses the data processing engine 184b2 to format the input prompt into a data processing schema required for the approved service. In some embodiments, the approved service may not have the data processing schema, and the prompt generation engine 184b may ask (i.e., prompt) the machine learning model directly regarding what kind of input prompt format would enable the respective machine learning model to provide the best/optimal output.

As an illustrative example, an approved service may have a machine learning model, an API schema requiring an input prompt to be in “text” and encoded in UTF-8 format, and a data processing schema indicating that the machine learning model prefers short, separate sentences. When the prompt generation engine 184b generates an input prompt, the prompt generation engine 184b may use the data format engine 184b1 to format the input prompt to be in “text” and encoded in UTF-8 format, as required in the mode specific format (e.g., API schema). The prompt generation engine 184b may also use the data processing engine 184b2 to split different paragraphs of the input prompt into short, separate sentences to format the input prompt as defined in the data processing schema.

For example, the input prompt before applying the data format engine 184b1 requiring “text” format and the data processing engine 184b2 requiring short, separate sentences may be: “Artificial intelligence (AI) is a rapidly evolving field that is revolutionizing industries from healthcare to finance. By automating tasks and providing data-driven insights, AI technologies are enhancing efficiency and opening up new possibilities for innovation. In 2023, the AI market was valued at $100 billion”.

The input prompt after applying the data format engine 184b1 requiring “text” format and the data processing engine 184b2 requiring short, separate sentences may be: “Artificial intelligence (AI) is a rapidly evolving field. It is revolutionizing industries from healthcare to finance. AI is automating tasks. It provides data-driven insights. AI technologies are enhancing efficiency. They are opening up new possibilities for innovation. In twenty twenty-three, the AI market was valued at one hundred billion dollars”.

The prompt generation engine 184b generally is or includes a machine learning model trained with a plurality of training intents, a plurality of training inputs, a plurality of subsequent inputs, and/or a plurality of context data to output a plurality of training sets of input prompts. However, in certain embodiments, the prompt generation engine 184b is or includes a function or algorithm that executes a pre-set list of rules to generate an input prompt.

The prompt engineering engine 180 generally executes the input request creation engine 184a to generate an input request after receiving an initial input from a user. For example, the initial input may be a request to generate a resume. The prompt engineering engine 180 may determine one or more intents corresponding to the initial input using the intent detection engine 184aa. The intent detection engine 184aa may additionally use the context data 184d indicating a user conversation history and a set of user background information to determine the one or more intents. The set of user background information can include one or more of (i) a tone consistency value, (ii) a performance indicator value, and (iii) a mission statement.

As an illustrative example of determining the one or more intents, the user conversation history may comprise questions regarding a software engineer job, and the user's background information may comprise information on the user's writing style being professional and ambitious (i.e., tone consistency value) and the user having excellent job performance (i.e., performance indicator value). The intent detection engine 184aa may use this information to determine one or more intents including “ambitious”, “software engineering”, “high achiever”, “professional”, etc.

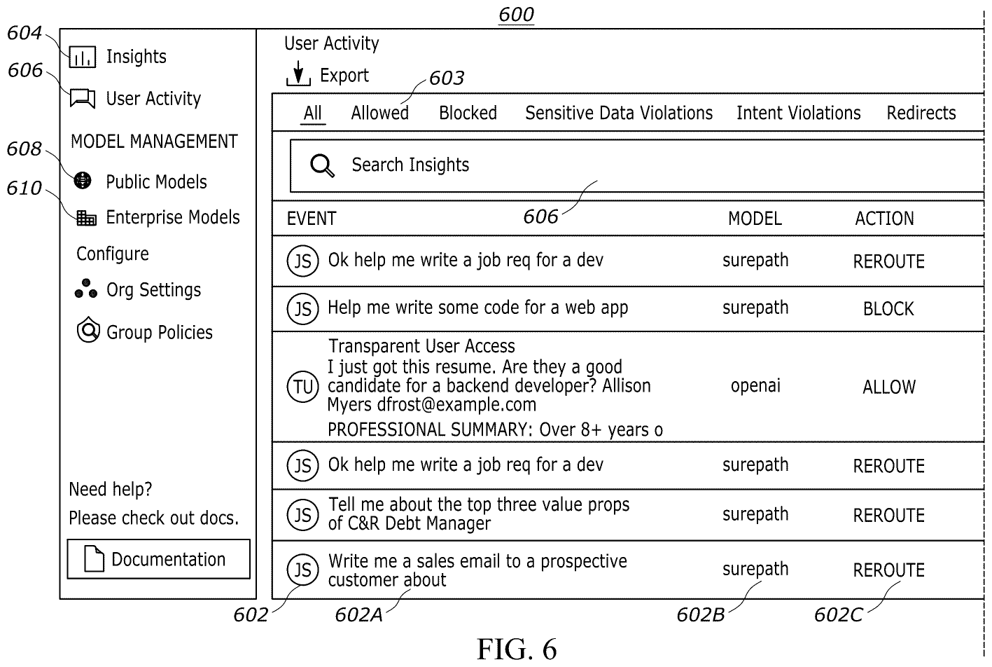

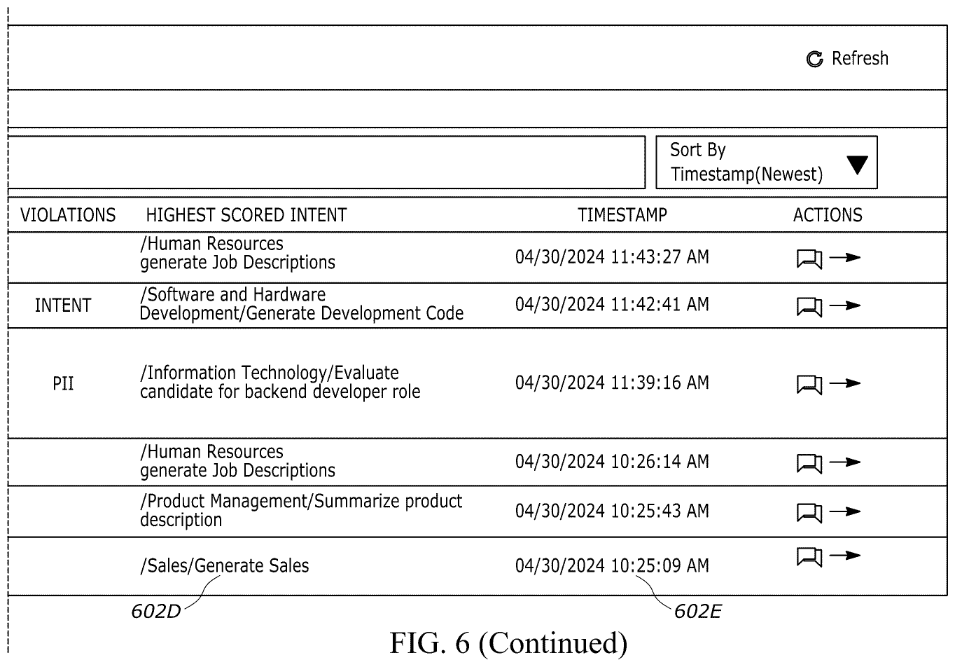

The input request creation engine 184a can use the initial input, the intent, and/or the context data 184d to generate a set of input requests for the user. The set of input requests may be requests sent by the input request creation engine 184a to obtain further information on the initial input. For example, if the initial input is “generate a resume”, then the set of input requests may be “what is your name?”, “what is your work experience?”, etc. An example set of input requests is described herein in reference to FIG. 6.

Broadly speaking, the input request creation engine 184a is or includes a machine learning model trained with a plurality of training intents, a plurality of training inputs, and/or a plurality of context data to output a plurality of training sets of input requests. Therefore, the input request creation engine 184a is or includes a trained machine learning model. The input request data 184d6 may be part of the plurality of training sets of input requests to train the machine learning model. The chat history data 184d5 may be part of the plurality of training inputs the input request creation engine 184a uses to train the machine learning model.

In certain embodiments, the input request creation engine 184a may be a semantic matching engine. The semantic matching engine may match certain key vocabularies or meanings from the initial input, the intent, and/or context data 184d to certain input request data 184d6. For example, when the user inputs a request to generate a resume, the semantic matching engine may recognize the word “resume” and proceed to retrieve an input request associated with the “resume” from the input request data 184d6.

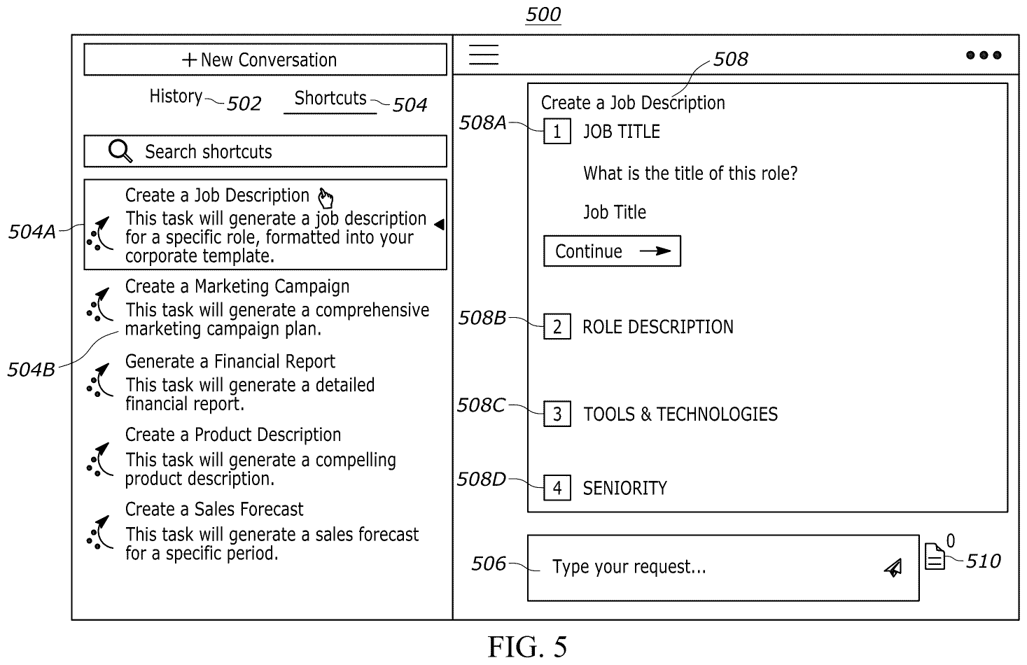

In some embodiments, the input request creation engine 184a is an event handler engine configured to generate a set of input requests upon receiving input data received through a user's interaction with an input request box. A user device may display a user interface with a plurality of input request boxes. Each input request box is generally associated with a particular set of input requests, and the users' interaction with an input request box (e.g., click, tap, swipe, gesture, voice command, etc.) generally serves as the input data. In response to the receiving user's input associated with an input request box, the input request creation engine 184a generates a set of input requests corresponding to the input request box. The example user interface may display a plurality of input request boxes on one side of the user interface, while another side of the user interface may display a chat like interface, where the set of input requests can be displayed. FIG. 5 illustrates a user interface with the plurality of input request boxes, and an example set of input requests.

The diagnostics engine 184c generally generates diagnostics reports associated with the prompt engineering engine 180. The diagnostics engine 184c may generate multiple different types of diagnostics reports, such as user activities diagnostics reports and insights diagnostics reports. Generally, each diagnostics report stores and/or otherwise indicates activities of at least one user, including different types of approved services used by the user(s), allowed activities, blocked activities, sensitive data violations, intent violations, redirected requests, most frequently searched intents, most frequently used machine learning model, and/or other activities or combinations thereof. Each activity of the user may comprise the user's profile, the request content, the approved service used to execute/evaluate the request, the type of action (e.g., allowed request, redirected, blocked, etc.), a time stamp, an intent of the request, etc. An example diagnostics report may comprise a plurality of users, with each user's activity sorted into a list. The list may be ordered by timestamps, such that the user activities are sorted chronologically. An example of a user's activity may include a user's name (“Joan Smith”), requested content (“Help me write a job request”), the approved service (“OpenAI”), the type of action (“Reroute”), etc. Details relating to the diagnostics report are illustrated and further discussed in reference to FIG. 6.

In certain embodiments, the diagnostics engine 184c may generate diagnostics reports at different levels, such as diagnostics reports tailored to a specific user, tailored to a group, tailored to a specific enterprise, etc. For example, the diagnostics engine 184c may generate a diagnostics report for activities of a set of employees in information technology (IT) department (i.e., the IT department being a group). In another example, the diagnostics engine 184c may generate a diagnostics report for activities of all a company's employees (i.e., the entire company being an enterprise).

Further, in some embodiments, the diagnostics engine 184c may designate diagnostics reports accessible only to a set of users with specific permissions. For example, the diagnostics engine 184c may designate a first diagnostics report as accessible only to manager-level employees of a first enterprise using the prompt engineering engine 180, and the diagnostics engine 184c may designate a second diagnostics report as accessible to all employees of the first enterprise. Thus, when a user attempts to generate/access the first and second diagnostics reports, the diagnostics engine 184c may (1) allow the user to generate/access the second diagnostics report and (2) determine whether the user has permission (i.e., is a manager-level employee) to generate/access the first diagnostic report. In some embodiments, the diagnostics engine 184c may have an administrative mode that may be accessed only upon entering a password.

In some embodiments, the diagnostics report may be used as part of the context data when generating an input prompt. Depending on the diagnostics report level (e.g., individual user, group, enterprise, etc.), the prompt generation engine 184b may incorporate the diagnostics report to generate data-rich input prompts using the diagnostics included therein. For example, the diagnostics report may display a plurality of user activities for different users in an enterprise. The diagnostics report may be classified as part of the enterprise data 184d3, and the prompt generation engine 184b may use the diagnostics included in the diagnostics report to generate a data-rich input prompt corresponding to the enterprise.

As previously mentioned, the context data 184d may comprise a set of entity data 184d1, a set of group data 184d2, a set of enterprise data 184d3, a set of public data 184d4, a set of chat history data 184d5, and a set of input request data 184d6. The set of entity data 184d1 can be data associated with an individual. This may include the individual's chat history data, individual's profile (e.g., the individual's years of experience, position, name, location, skills, etc.), input requests used by the user, etc. The set of group data 184d2 may be or include the data of a group associated with the user. As an example, a group associated with the user may be one or more other users with the same profession or title as the user. Another example of a group may be one or more other users withing the same enterprise office as the user. The set of group data 184d2 may include chat history data of all the users within the group, profiles of users within the group, input requests of users within the group, etc. The set of enterprise data 184d3 may be or include the data of an enterprise associated with the user. As an example, an enterprise may be a company where the user is employed. The enterprise data may comprise chat history data of all the users within the enterprise, profiles of users within the enterprise, input requests of users within the enterprise, etc. The set of public data 184d4 may be or include some/all the data of every user using the prompt engineering engine 180.

Each of these sets of data (e.g., 184d1-4) may be associated with a particular context relevancy level, as previously described. For example, the set of entity data 184d1 may be associated with a first/most relevant context relevancy level, the set of entity data 184d2 may be associated with a second most relevant context relevancy level, the set of enterprise data 184d3 may be associated with a third most relevant context relevancy level, and the set of public data 184d4 can be the least relevant context relevancy level. Accordingly, the context relevancy level associated with the set of entity data 184d1 may be called an entity level, the context relevancy level associated with the set of group data 184d2 may be called a group level, the context relevancy level associated with the set of enterprise data 184d3 may be called an enterprise level, and the context relevancy level associated with the set of public data 184d4 may be called a public level.

The chat history data 184d5 generally is or includes chat data stored by the prompt engineering engine 180. The chat data may comprise a plurality of different chats, where each chat may have context data specific to the conversation a user conducted in that chat. For example, one chat may include a user asking questions regarding how to cook certain food, while another chat may include a user asking to summarize various new articles. The chat including cooking questions may have context data related to cooking, while the chat including news articles requests may have context data related to the news articles.

The input request data 184d6 generally is or includes sets of input requests stored in the prompt engineering engine 180. When the prompt engineering engine 180 generates a set of input requests, the prompt engineering engine 180 may choose from the sets of input requests stored in the input request data 184d6. When the prompt engineering engine 180 generates a new set of input requests, the new set of input requests may be stored in the input request data 184d6. A user interface can comprise different chat boxes and input request boxes. Each chat box may represent a different chat with context data specific to the chat, which are part of the chat history data 184d5. Each input request box may correspond to a different set of input requests, which are part of the input request data 184d6. The chat boxes and the input request boxes are illustrated and discussed further in reference to FIG. 5.

More generally, the one or more processors 182 may include any suitable number of processors and/or processor types. For example, the processors 182 may include one or more CPUs and one or more graphics processing units (GPUs). Generally, each of the processors 182 may be configured to execute software instructions stored in the corresponding one or more memories 184. The memories 184 may include one or more persistent memories (e.g., a hard drive and/or solid-state memory) and may store one or more applications, modules, and/or models, such as the input request creation engine 184a, prompt generation engine 184b, and/or the diagnostics engine 184c.

The networking interface 186 may enable the prompt engineering engine 180 to communicate with other devices, and/or any other suitable devices or combinations thereof. The networking interface 186 may support wired or wireless communications, such as USB, Bluetooth, Wi-Fi Direct, Near Field Communication (NFC), etc. The networking interface 186 may enable the prompt engineering engine to communicate via a wireless communication network such as a fifth-, fourth-, or third-generation cellular network (5G, 4G, or 3G, respectively), a Wi-Fi network (802.11 standards), a WiMAX network, or any other suitable wide area network (WAN), local area network (LAN), or personal area network (PAN), etc. Moreover, the network may be a single communication network, or may include multiple communication networks of one or more types (e.g., one or more wired and/or PANs or LANs, and/or one or more WANs such as the Internet).

### Example Prompt Engineering Workflow

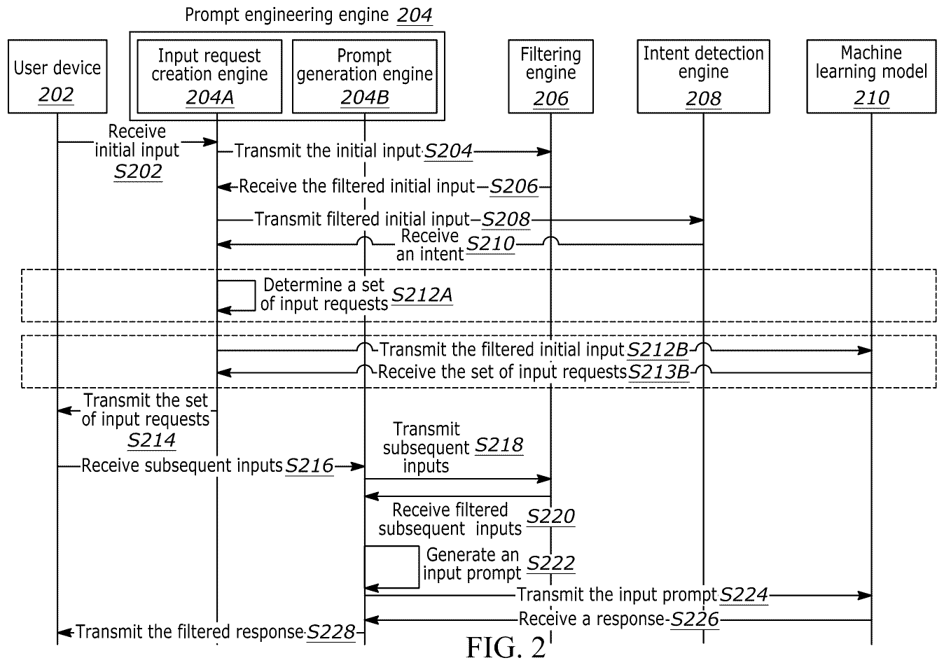

FIG. 2 depicts a flow diagram of a prompt engineering session according to some embodiments. FIG. 2 can comprise a user device 202, a prompt engineering engine 204, a filtering engine 206, an intent detection engine 208, and a machine learning model 210, and they can each transmit or receive signal S (e.g., S202, S204) to themselves or to each other to perform the prompt engineering session. The prompt engineering engine 204 can comprise an input request creation engine 204A and a prompt generation engine 204B. The machine learning model 210 may be part of an approved service. The intent detection engine 208 may be separate from the prompt engineering engine 204 in FIG. 2. A user may use the user device 202 to use the prompt engineering engine 204. In some embodiments, the filtering engine 206 may be the data loss prevention engine 120 of FIG. 1B.

For signal S202, the user may use the user device 202 to transmit the signal S202 including an initial input to a prompt engineering engine 204. The initial input may be a request to perform a task such as a request to generate a resume, generate a product description, creating a business proposal, etc. In some embodiments, the initial input may be context data for subsequent requests. For example, the user may transmit a research paper, and may subsequently request to perform a task such as requesting to summarize the research paper, requesting to write a paper with similar semantics as the research paper, etc. The initial input may comprise one or more of an alphanumeric string, a file, image data, and/or audio data.

For signal S204, upon receiving the initial input from the user of the user device, the prompt engineering engine 204 transmits the signal S204 including the initial input to a filtering engine 206. The filtering engine 206 may filter any sensitive information from the initial input, and the prompt engineering engine 204 may receive a signal S206 including the filtered initial input from the filtering engine 206. The filtering of the sensitive information may depend on a user's portfolio, a user's enterprise, the type of machine learning model 210 used by the user, etc. The filtering may also determine the course of action to take (e.g., BLOCK, REROUTE, ALLOW, etc.) and determine the types of violations of the initial input. For example, the filtering engine 206 may filter out proprietary information, reject requests deemed inappropriate, etc.

For signal S208, the prompt engineering engine 204 transmits the signal S208 including the filtered initial input to the intent detection engine 208. The intent detection engine 208, upon receiving the filtered initial input, determines one or more intents corresponding to the filtered initial input. For example, if the filtered initial input is “to generate a resume for a person with a computer science degree”, then the intents for the filtered initial input may be “generating a resume”, “computer science degree”, etc.

In some embodiments, the signals S204 and S206 may be transmitted/received after determining intents of the initial input. In these embodiments, the prompt engineering engine 204, upon determining intents of the initial input (e.g., via the intent detection engine 20-), may transmit both the initial input and the intents to the filtering engine 206. The filtering engine 206, upon receiving the initial input and the intents, may filter the initial input based on the intents. For example, if the intents classify the initial input as “dangerous”, then the filtering engine 206 may filter reject the initial input.

For signal S210, the intent detection engine 208 may transmit the signal S210 including the one or more intents to the input request creation engine 204A. The prompt engineering engine 204, thereby receives the one or more intents of the filtered initial input. Upon receiving the one or more intents, the prompt engineering engine 204 may evaluate two options to generate a set of input requests. One option is illustrated in signal S212A, and another option is illustrated in signals S212B and S213B.

For signal S212A, upon receiving the one or more intents, the prompt engineering engine 204 can transmit the signal S212A including the initial input, the one or more intents, and/or context data, and a request to an input request creation engine 204A. The prompt engineering engine 204 may apply the input request creation engine 204A to the initial input and the request to generate the set of input requests.

The input request creation engine 204A may be a machine learning model that has been trained by using a plurality of training intents and a plurality of training inputs to output a plurality of training set of input requests. The machine learning model may apply the initial input, the one or more intents, and/or context data received from the prompt engineering engine 204 to determine the one or more intents.

The first option as demonstrated in signal S212A may be used when the initial input is an input that the prompt engineering engine 204 had received in the past. For example, requests such as “generate a resume” and “generate a business proposal” may be common requests for which the prompt engineering engine 204 has previously generated a set of input requests. In such a case, similar inputs/requests may have been part of the plurality of training inputs, and the input request creation engine 204A (e.g., a machine learning model) may transmit the signal S212A to itself to generate the set of input requests that could help the user develop more personalized and comprehensive subsequent inputs in response to the set of input requests.

For signal S212B, the prompt engineering engine 204 may transmit the signal S212B including the initial input, the one or more intents, and/or context data, and a request to the machine learning model 210. The machine learning model 210 may be configured to generate the set of input requests, and the machine learning model may apply the initial input, the one or more intents, and/or context data to generate the set of input requests. The request may comprise asking the machine learning model 210 what additional types of information the machine learning model 210 may require and/or would otherwise benefit from to generate an optimal output in response to the initial input. The machine learning model 210, in response to the request, may generate the set of input requests based on the initial input, the one or more intents, and/or context data. Consequently, for signal S213B, the prompt engineering engine 204 may receive the signal S213B including the set of input requests from the machine learning model.

The prompt engineering engine 204 may use a data format engine when transmitting the initial input, the one or more intents, and/or context data, and the request to the machine learning model to meet the mode specific format (e.g., API standard) the machine learning model 210 requires. For example, the data format engine may require that the data is formatted correctly and adheres to the required structure, such as specifying JSON or XML formats, including necessary headers, and properly organizing the payload.

The second option as demonstrated in signals S212B and S213B may be used when the prompt engineering engine 204 does not have enough training inputs to train the model, or the initial input is a unique input that the prompt engineering engine 204 has not encountered and/or otherwise analyzed before. The prompt engineering engine 204 may use the set of input requests by the machine learning model 210 as part of the plurality of training input requests when training the input request creating engine 204A.

In certain instances, the user has an option when determining the set of input requests to choose the first option (S212A) or the second option (S212B and S213B). In some embodiments, the prompt engineering engine 204 may automatically determine a best/preferred option. In certain embodiments, only a group of users with particular permissions may choose which the best/preferred option.

For signal S214, the prompt engineering engine transmits or provides the signal S214 including the set of input requests to the user device 202. For signal S216, upon the user device receiving the set of input requests, the user may transmit or provide the signal S216 including one or more subsequent inputs to the set of input requests, which the prompt engineering engine 204 receives. The one or more subsequent inputs can be responses provided by the user to the set of input requests. Although the one or more subsequent inputs are provided to the user device, the user may not be required to provide a subsequent input to every input request.

For signal S218, the prompt engineering engine 204 transmits the signal S218 including the one or more subsequent inputs to the filtering engine 206. The filtering engine 206 may filter any sensitive information from the one or more subsequent inputs. Similar to the filtering performed in signals S204 and S206, the filtering of the sensitive information may depend on a user's portfolio, a user's enterprise, the type of machine learning model 210 used by the user, etc. For signal S220, the prompt engineering engine 204 may receive the signal S220 including the filtered subsequent inputs from the filtering engine 206.

For signal S222, the prompt engineering engine 204 may proceed to transmit the signal S222 to itself to generate an input prompt. The prompt engineering engine 204 can apply a prompt generation engine 204B to the intent, the initial input, the one or more subsequent inputs, and/or the context data to output an input prompt. When generating the input prompt, the prompt generation engine 204B may use data processing engine 124b2 to determine the type of input prompt that provides the best output. For example, one model may require a different structure of the input prompt than another model to determine the best output.

When determining whether the input prompt has sufficient information for the machine learning model 210 to adequately produce a desired output, the prompt generation engine 204B may use a context threshold. The context threshold may be a threshold in which the prompt generation engine 204B can use to determine whether the input prompt comprises sufficient context information to generate a comprehensive response by the machine learning model. The context threshold can be defined in several ways, such as but not limited to a minimum number of sentences or word counts in an input prompt, a minimum vector similarity score (e.g., cosine similarity score) through vector embeddings to ensure that the context aligns with the input prompt, and/or a minimum relevancy score (e.g., named entity recognition score) to ensure relevant entities/information exist in the input prompt.

As previously mentioned, the context data may be divided into four different context relevancy levels of decreasing relevance: entity data (e.g., most relevant), group data, enterprise data, and public data (e.g., least relevant). The prompt generation engine 204B may begin including data within the first context relevancy level (e.g., entity data) and may determine that the data from this first level fails to satisfy the context threshold. The prompt generation engine 204B may then incorporate additional context data by adjusting from the first context relevancy level to a second context relevancy level. The second context relevancy level may be group data, the enterprise data, or the public data. If the second context relevancy level does not meet the context threshold, the prompt generation may progressively include additional context data from any suitable context relevancy level until the prompt generation engine 204B determines that the context threshold is satisfied.

For signal S224, the prompt generation engine 204B may transmit the signal S224 including the input prompt to the machine learning model 210. As part of this transmission, the prompt engineering engine 204 may use a data format engine to meet the API standard required by and/or otherwise associated with the machine learning model 210.

The machine learning model 210 and other engines of the prompt engineering engine 180 (e.g., input request creation engine 184a, prompt generation engine 184b, etc.) that uses machine learning model may be configured to implement machine learning, such that the model/engine “learns” to analyze, organize, and/or process data without being explicitly programmed. Machine learning may be implemented through machine learning methods and algorithms. In one exemplary embodiment, a machine learning module may be configured to implement machine learning methods and algorithms.

In some embodiments, at least one of a plurality of machine learning methods and algorithms may be applied, which may include but are not limited to: linear or logistic regression, instance-based algorithms, regularization algorithms, decision trees, Bayesian networks, naïve Bayes algorithms, cluster analysis, association rule learning, neural networks (e.g., convolutional neural networks, deep learning neural networks, combined learning module or program), deep learning, combined learning, reinforced learning, dimensionality reduction, support vector machines, k-nearest neighbor algorithms, random forest algorithms, gradient boosting algorithms, Bayesian program learning, voice recognition and synthesis algorithms, image or object recognition, optical character recognition, natural language understanding, and/or other ML programs/algorithms either individually or in combination. In various embodiments, the implemented machine learning methods and algorithms are directed toward at least one of a plurality of categorizations of machine learning, such as supervised learning, unsupervised learning, and reinforcement learning.

In one embodiment, the machine learning model 210 and the other machine learning engines (e.g., input request creation engine 184a and prompt generation engine 184b) may employ supervised learning, which involves identifying patterns in existing data to make predictions about subsequently received data. Specifically, the machine learning model 210 and the other machine learning engines may be “trained” using training data, which includes example inputs and associated example outputs. Based upon the training data, the machine learning model 210 and the other machine learning engines may generate a predictive function which maps outputs to inputs and may utilize the predictive function to generate machine learning outputs based upon data inputs.

In another embodiment, the machine learning model 210 and the other machine learning engines may employ unsupervised learning, which involves finding meaningful relationships in unorganized data. Unlike supervised learning, unsupervised learning does not involve user-initiated training based upon example inputs with associated outputs. Rather, in unsupervised learning, the machine learning model 210 and the other machine learning engines may organize unlabeled data according to a relationship determined by at least one machine learning method/algorithm employed by the machine learning model 210 and the other machine learning engines. Unorganized data may include any combination of data inputs and/or machine learning outputs as described above.

In yet another embodiment, the machine learning model 210 and the other machine learning engines may employ reinforcement learning, which involves optimizing outputs based upon feedback from a reward signal. Specifically, the machine learning model 210 and the other machine learning engines may receive a user-defined reward signal definition, receive a data input, utilize a decision-making model to generate a machine learning output based upon the data input, receive a reward signal based upon the reward signal definition and the machine learning output, and alter the decision-making model so as to receive a stronger reward signal for subsequently generated machine learning outputs. Other types of machine learning may also be employed, including deep or combined learning techniques.

After training, machine learning programs (or information generated by such machine learning programs) may be used to evaluate additional data. Such data may be and/or may be related to intent data, user device data, and/or other data that was not included in the training dataset. The trained machine learning programs (or programs utilizing models, parameters, or other data produced through the training process) may accordingly be used for determining, assessing, analyzing, predicting, estimating, evaluating, or otherwise processing new data not included in the training dataset.

It is to be understood that supervised machine learning and/or unsupervised machine learning may also comprise retraining, relearning, or otherwise updating models with new, or different, information, which may include information received, ingested, generated, or otherwise used over time.

Moreover, although the methods described elsewhere herein may not directly mention machine learning techniques, such methods may be read to include such machine learning for any determination or processing of data that may be accomplished using such techniques. In some aspects, such machine learning techniques may be implemented automatically upon occurrence of certain events or upon certain conditions being met. In any event, use of machine learning techniques, as described herein, may begin with training a machine learning program, or such techniques may begin with a previously trained machine learning program.

The machine learning model 210 can be a public machine learning model or a private machine learning model. The public machine learning model may be a machine learning model that is widely accessible and available to the public, often provided by third-party vendors or open-source communities. These models are typically pre-trained on large datasets and can be used for a variety of applications, offering the benefit of community support and ongoing updates. In contrast, a private machine learning model is specifically developed and maintained within an organization, tailored to its unique data and requirements. These private models offer greater control over data privacy, customization, and optimization for specific tasks, ensuring that the machine learning solutions align closely with the organization's goals and operational needs.

For signal S226, the machine learning model 210 may output a response to the input prompt and transmit the signal S226 including the response to the prompt engineering engine 204. For signal S228, the prompt engineering engine 204, upon receiving the response to the input prompt, may transmit the signal S228 including the response to the user device 202 for viewing by the user.

In some embodiments, before sending the response to the user device, the prompt engineering engine 204 may filter the response by using the filtering engine 206 to filter out any private and/or otherwise inappropriate information contained in the response.

### Example Context Data

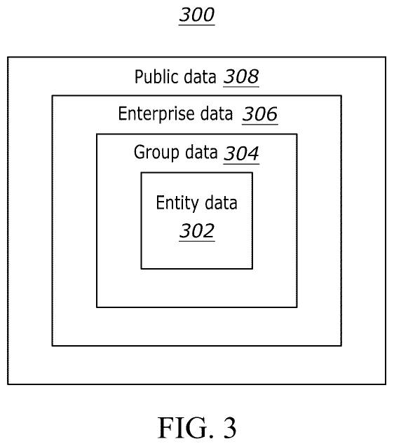

FIG. 3 represents a plurality of context relevancy levels 300: entity data 302, group data 304, enterprise data 306, and public data 308. The entity data 302 may be the most relevant context data, with the group data 304 being the second most relevant, the enterprise data 306 being the third most relevant, and the public data 308 being the least relevant. As represented in FIG. 3, the most relevant data may be part of and/or otherwise included within the less relevant data. For example, the entity data 302 may be part of the group data 304.

The entity data 302 may represent data specific to the user. The entity data 302 may encompass information specific to individual users, forming a personalized dataset unique to each user. For example, the entity data 302 includes, but is not limited to, user preferences, behavioral patterns, interaction history, a user's job description/title, demographic details, a user's most frequent intents, personalized settings, etc. Individual chat histories of the user may also be part of the entity data 302.

The group data 304 may represent data specific to the user's group. The user's group can be the user's team at work but may also represent other groups that are associated with the user. For example, the user may be working as a software engineer, and the user's entity data 302 may consequently be included as part of group data 304 associated with the IT group. The group data 304 may represent types of inputs most frequently used by the group, types of intents most commonly linked to the group, the type of machine learning model most commonly used by the group, etc. The group data 304 may also include entity data of every individual within the group. As illustrated, the group data 304 may not be as relevant as the entity data 302, but may still provide more information about the user. Additionally, the entity data 302 may be part of the group data.

The enterprise data 306 may represent data specific to the user's company and/or any other organization with which the user is associated. The enterprise data 306 may represent types of inputs most frequently used by the enterprise, types of intents most commonly linked to the enterprise, a mission statement of the enterprise, the type of work done by the enterprise, the type of machine learning model the enterprise uses, etc. The enterprise data 306 may include the group data 304 of every group within the enterprise. As illustrated, the enterprise data 306 may not be as relevant as the entity data 302 and group data 304, but may provide more information about the user. The entity data 302 and the group data 304 may be part of the enterprise data 306.

The public data 308 generally represents public data accessible by the prompt engineering engine, and may be any type(s) of data accessible to the prompt engineering engine. With exception to certain private datasets, the public data 308 may be any type of data that has been collected from the users of the prompt engineering engine. The public data may include types of intents most commonly linked in the prompt engineering engine, the machine learning model most often used by the prompt engineering engine, etc. The public data may include the enterprise data 306 of every enterprise using the prompt engineering engine. As illustrated, the public data 308 may not be as relevant as the entity data 302, group data 304, and the enterprise data, but may provide more information about the user. The entity data 302, group data 304, and the enterprise data may be part of the public data 308.

Some/all of the data within these context relevancy levels 300 may contribute to satisfying a context threshold. As previously discussed, the context threshold may be satisfied depending on how much information is available. For example, if a user of a prompt engineering engine is a new user with a relatively minimal chat history, then that user may not have enough corresponding entity data 302 to meet the context threshold, which causes the prompt engineering engine to evaluate the next context relevancy level of data such as the group data 304, enterprise data 306, and/or public data 308.

### Example Graphical User Interfaces (GUIs)

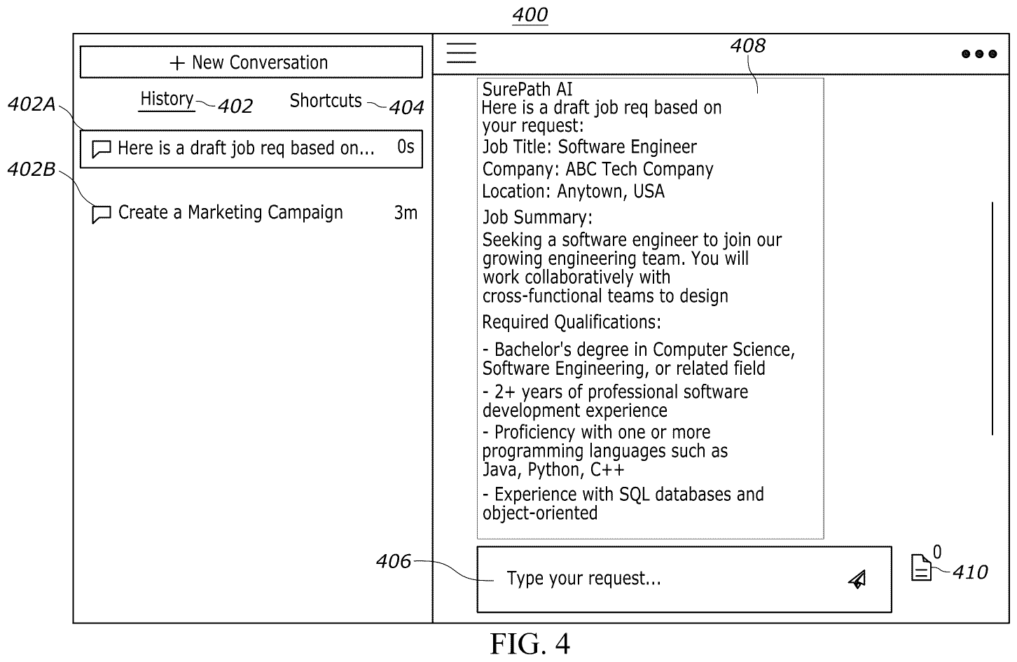

FIG. 4 illustrates a user interface 400 with different chat boxes, illustrated according to some embodiments. The user may interact with various portions of the user interface 400 to send an input and receive a response as an output. The user interface 400 can comprise a chat history 402, input request boxes 404, a textbox 406, an example input 408, and a file button 410. The chat history 402 includes a first chat history 402A and a second chat history 402B. The user can use the user interface 400 to navigate through different chat instances by selecting different chat boxes (e.g., first chat history 402A and second chat history 402B).

The user interface 400 can include a plurality of chat boxes in the chat history 402, as demonstrated by the first chat history 402A and the second chat history 402B. Each chat box may be a respective chat instance of the user, and each chat instance may have respective chat context. For example, one chat instance may have chat context relating to “creating a marketing campaign” while another chat context may have a chat context relating to “drafting a job requirement”. The current chat instance as displayed in FIG. 4 may be the first chat history 402A.

The first chat history 402A may have chat context relating to “drafting a job requirement”. A prompt engineering engine 180 may determine chat context of the chat instance based on the user's past/prior inputs to the chat instance. In some embodiments, a machine learning model associated with the chat instance may determine the chat context of the chat instance. As illustrated in FIG. 4, the example input 408 comprises details relevant to drafting a job requirement.

The prompt engineering engine 180 may rank the plurality of chat boxes in chat history 402 based on context data. For example, the chat boxes may be ranked based on importance of the context data to the user. The prompt engineering engine 180 may use the importance of the context data based on the relevancy of the chat context to the user. In another example, the prompt engineering engine 180 can rank the chat boxes based on the most recent chat box accessed by the user.

The user may enter the inputs using the textbox 406. The user may not be limited to alphanumeric strings, and may attach different files and images through the file button 410.

FIG. 5 depicts a user interface 500 with different input request boxes, illustrated according to some embodiments. The user may use the user interface 500 to select an input request box among input request boxes 504. The user interface 500 can include a chat history 502, input request boxes 504, a textbox 506, an example set of input requests 508, and a file button 510. The input request boxes 504 includes a first input request box 504A, a second input request box 504B, and other input request boxes, as illustrated in FIG. 5.

The user interface 500 can include a plurality of input request boxes, as shown in the input request boxes 504. Each input request box (e.g., 504A, 504B) of the plurality of input request boxes can be a respective set of input requests. For example, the first input request box 504A may represent a set of input requests to create a job description. The second input request box 504B may represent a set of input requests to create a marketing campaign. The prompt engineering engine 180 may rank the plurality of input request boxes based on context data. For example, the prompt engineering engine 180 can determine which set of input requests is most relevant to the user.

The user interface 500 displays the example set of input requests 508 corresponding to the first input request box 504A. The example set of input requests 508 includes a set of input requests, including a first input request 508A requesting a job title, a second input request 508B requesting a role description, a third input request 508C requesting tools and technologies, and a fourth input request 508D requesting a seniority level. The user may provide one or more subsequent inputs to the example set of input requests 508.

The user may enter the inputs (e.g., in response to the set of input requests 508) in the textbox 506. The user may not be limited to alphanumeric strings, and may attach different files and images through the file button 510.

FIG. 6 illustrates a user activity diagnostics report 600 provided to the user. The user activity diagnostics report 600 as illustrated in FIG. 6 includes an insight button 604, a user activity button 606, a public model button 608, and an enterprise model button 610. Upon clicking the user activity button 606, the user may receive the user activity diagnostics report 600, as illustrated in FIG. 6, including a set of user activities 602, an actions menu 603, and a search bar 605. Each user activity in the set of user activities 602 may comprise an input 602A, a model 602B, an action 602C, one or more intents 602D, and a timestamp 602E.

The insight button 604 may direct the user to an insight diagnostics report (not shown) associated with the user. The insight diagnostics report may include details regarding the user, the group associated with the user, and/or enterprise associated with the user. These details may indicate, for example, a set of frequently determined intents, time values associated with a chat, a set of frequently used sets of input requests, most commonly used machine learning models, times when prompt engineering engine is most active, etc.

As mentioned, the user activity button 606 may direct the user to the user activity diagnostics report 600. Each user activity is generally created whenever the user transmits an input to the prompt engineering engine. The set of user activities 602 may include user activities of multiple, different users. These multiple, different users may each be part of the same group or the same enterprise. Additionally, or alternatively, the set of user activities 602 may include multiple user activities for the same user. In certain embodiments, the set of user activities 602 includes the user's name and the user's profile photo in addition to the input 602A.

Generally, the model 602B can be a type of machine learning model used by the prompt engineering engine to generate a response. The machine learning model indicated by the model 602B may be selected by the user or may be selected by the prompt engineering engine, depending on the input. The action 602C and violations may be determined by the filtering engine, which determines whether the input should be redirected to a different model, blocked, or allowed. The intents 602D associated with the input and the timestamp 602E indicating when the input was transmitted can also be displayed as part of the user activity diagnostics report 600.

The public model button 608 may direct the user to a set of public models offered to the user. The set of public models may be machine learning models that have been trained with public data that could be utilized by the users using the prompt engineering engine. The enterprise model button 610 may direct the user to a set of private models offered to the user. The set of private models may be machine learning models specifically trained, for example, using group data and/or enterprise data. The user may select which machine learning model to use as the prompt engineering engine from the set of public models or the set of private models.

In certain embodiments, the user activity diagnostics report 600 and the machine learning model used as the prompt engineering engine may be accessible only to a set of users with particular permission(s). For example, only managers of an enterprise may be able to see the user activity diagnostics report 600, and/or make changes to the machine learning model(s) that may be used as the prompt engineering engine.

### Example Computer-Implemented Methods

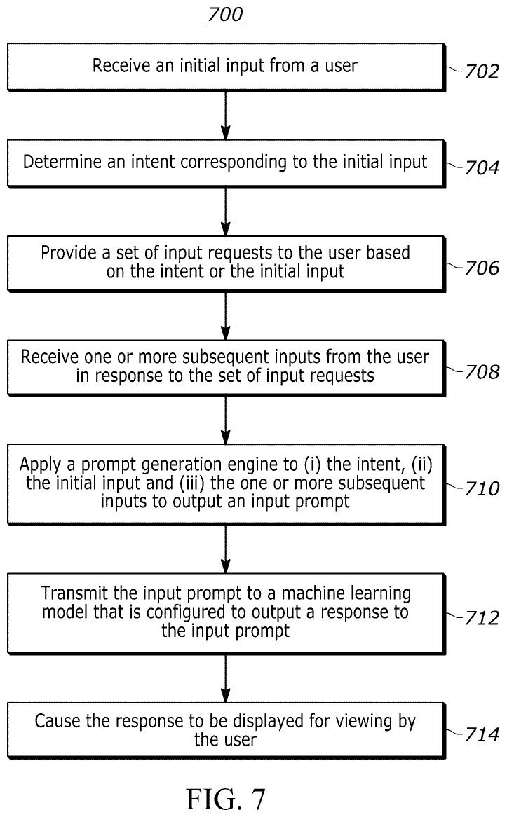

FIG. 7 depicts a flow diagram representing an example computer-implemented method 700, in accordance with various embodiments described herein. The method 700 may be implemented by one or more processors of the example computing system 100.

The method 700 includes receiving an initial input from a user (block 702). The method 700 further includes determining an intent corresponding to the initial input (block 704). The method 700 further includes providing a set of input requests to the user based on the intent or the initial input (block 706). The method 700 further includes receiving one or more subsequent inputs from the user in response to the set of input requests (block 708).

The method 700 further includes applying a prompt generation engine to (i) the intent, (ii) the initial input, and (iii) the one or more subsequent inputs to output an input prompt (block 710). The method 700 further includes transmitting the input prompt to a machine learning model that is configured to output a response to the input prompt (block 712). The method 700 further includes causing the response to be displayed for viewing by the user (block 714).

In certain embodiments, the method 700 further includes transmitting (i) the initial input, and (ii) a request to an input request creation engine configured to generate the set of input requests, applying the input request creation engine to the initial input and the request to generate the set of input requests, and receiving the set of input requests. In these embodiments, the method 700 further includes applying the input request creation engine to (i) the initial input, (ii) the request, and (iii) the intent to output the set of input requests. The input request creation engine is trained with a plurality of training intents and a plurality of training inputs to output a plurality of training sets of input requests.

In certain embodiments, the method 700 further includes transmitting (i) the initial input, and (ii) a request to the machine learning model configured to generate the set of input requests, wherein the machine learning model generates the set of input requests and receiving the set of input requests from the machine learning model.

In certain embodiments, the method 700 further includes determining the intent based on (i) the initial input and (ii) context data indicating a user conversation history and a set of user background information. In these embodiments, the set of input requests to the user is further based on the context data. Further in these embodiments, the method 700 further includes applying the prompt generation engine to (i) the intent, (ii) the initial input, (iii) the one or more subsequent inputs, and (iv) the context data to output the input prompt. In these embodiments, the set of user background information includes one or more of (i) a tone consistency value, (ii) a performance indicator value, and (iii) a mission statement. In these embodiments, the context data comprises a plurality of context relevancy levels, including: (i) an entity level, (ii) a group level, (iii) an enterprise level, and (iv) a public level. Still further in these embodiments, the prompt generation engine outputs the input prompt by determining that a first level of the plurality of context relevancy levels fails to satisfy a context threshold; and incorporating additional context data from the context data by adjusting from the first level of the plurality of context relevancy levels to a second level of the plurality of context relevancy levels, wherein the second level is at least one of: (i) the group level, (ii) the enterprise level, or (iii) the public level.

In certain embodiments, the machine learning model is from an approved service of a plurality of approved services. Further in these embodiments, each approved service of the plurality of approved services comprises: (i) a respective machine learning model, (ii) a respective API schema indicating a respective input prompt type, and (iii) a data processing schema indicating a respective input prompt format. Yet further in these embodiments, the method 700 includes applying the prompt generation engine to (i) the intent, (ii) the initial input, (iii) the one or more subsequent inputs, (iv) the respective API schema indicating a respective input prompt type, and (v) the data processing schema indicating a respective input prompt format.

In certain embodiments, the method 700 includes providing a user interface to the user that comprises a plurality of input request boxes and a plurality of chat boxes, wherein each input request box of the plurality of input request boxes correlates to a respective set of input requests, wherein each chat box of the plurality of chat boxes is a respective chat instance of the user, and wherein each chat instance has a respective chat context. Further in these embodiments, the initial input comprises one or more of: (i) an alphanumeric string, (ii) a file, (iii) image data, or (iv) audio data.

In certain embodiments, the method 700 includes generating a diagnostics report indicating one or more of: (i) a set of frequently determined intents, (ii) time values associated with a chat, or (iii) a set of frequently used sets of input requests. Further in these embodiments, the diagnostics report is accessible only to a set of users with a permission specified in corresponding user profile.

### EXAMPLES

The following list of examples reflects a variety of the embodiments explicitly contemplated by the present disclosure. Those of ordinary skill in the art will readily appreciate that the examples below are neither limiting of the embodiments disclosed herein, nor exhaustive of all of the embodiments conceivable from the disclosure above, but are instead meant to be exemplary in nature.

Example 1. A computer-implemented method for improved prompt engineering, comprising: receiving, by one or more processors, an initial input from a user; determining, by the one or more processors, an intent corresponding to the initial input; providing, by the one or more processors, a set of input requests to the user based on the intent or the initial input; receiving, by the one or more processors, one or more subsequent inputs from the user in response to the set of input requests; applying, by the one or more processors, a prompt generation engine to (i) the intent, (ii) the initial input, and (iii) the one or more subsequent inputs to output an input prompt; transmitting, by the one or more processors, the input prompt to a machine learning model that is configured to output a response to the input prompt; and causing, by the one or more processors, the response to be displayed for viewing by the user.

Example 2. The computer-implemented method of example 1, further comprising: transmitting, by the one or more processors, (i) the initial input, and (ii) a request to an input request creation engine configured to generate the set of input requests; applying the input request creation engine to the initial input and the request to generate the set of input requests; and receiving, by the one or more processors, the set of input requests.

Example 3. The computer-implemented method of example 2, further comprising: applying the input request creation engine to (i) the initial input, (ii) the request, and (iii) the intent to output the set of input requests, wherein the input request creation engine is trained with a plurality of training intents and a plurality of training inputs to output a plurality of training sets of input requests.

Example 4. The computer-implemented method of example 1, further comprising: transmitting, by the one or more processors, (i) the initial input, and (ii) a request to the machine learning model configured to generate the set of input requests, wherein the machine learning model generates the set of input requests; and receiving, by the one or more processors, the set of input requests from the machine learning model.

Example 5. The computer-implemented method of example 1, wherein the one or more processors further determine the intent based on (i) the initial input and (ii) context data indicating a user conversation history and a set of user background information.

Example 6. The computer-implemented method of example 5, wherein the set of input requests to the user is further based on the context data.

Example 7. The computer-implemented method of example 6, wherein the one or more processors further apply the prompt generation engine to (i) the intent, (ii) the initial input, (iii) the one or more subsequent inputs, and (iv) the context data to output the input prompt.

Example 8. The computer-implemented method of example 5, wherein the set of user background information includes one or more of (i) a tone consistency value, (ii) a performance indicator value, and (iii) a mission statement.

Example 9. The computer-implemented method of example 5, wherein the context data comprises a plurality of context relevancy levels, including: (i) an entity level, (ii) a group level, (iii) an enterprise level, and (iv) a public level.

Example 10. The computer-implemented method of example 9, wherein the prompt generation engine further outputs the input prompt by: determining that a first level of the plurality of context relevancy levels fails to satisfy a context threshold; and incorporating additional context data from the context data by adjusting from the first level of the plurality of context relevancy levels to a second level of the plurality of context relevancy levels, wherein the second level is at least one of: (i) the group level, (ii) the enterprise level, or (iii) the public level.

Example 11. The computer-implemented method of example 1, wherein the machine learning model is from an approved service of a plurality of approved services.

Example 12. The computer-implemented method of example 11, wherein each approved service of the plurality of approved services comprises: (i) a respective machine learning model, (ii) a respective API schema indicating a respective input prompt type, and (iii) a data processing schema indicating a respective input prompt format.

Example 13. The computer-implemented method of example 12, wherein the one or more processors applies the prompt generation engine to (i) the intent, (ii) the initial input, (iii) the one or more subsequent inputs, (iv) the respective API schema indicating a respective input prompt type, and (v) the data processing schema indicating a respective input prompt format.

Example 14. A computer system for improving prompt engineering comprising: one or more processors; and a non-transitory program memory coupled to the one or more processors and storing executable instructions that, when executed by the one or more processors, causes the computer system to: receive an initial input from a user; determine an intent corresponding to the initial input; provide a set of input requests to the user based on the intent or the initial input; receive one or more subsequent inputs from the user in response to the set of input requests; apply a prompt generation engine to (i) the intent, (ii) the initial input, and (iii) the one or more subsequent inputs to output an input prompt; transmit the input prompt to a machine learning model that is configured to output a response to the input prompt; and cause the response to be displayed for viewing by the user.

Example 15. The computer system of example 14, wherein the instructions, when executed by the one or more processors, further cause the computer system to: provide a user interface to the user that comprises a plurality of input request boxes and a plurality of chat boxes, wherein each input request box of the plurality of input request boxes correlates to a respective set of input requests, wherein each chat box of the plurality of chat boxes is a respective chat instance of the user, and wherein each chat instance has a respective chat context.

Example 16. The computer system of example 15, wherein the instructions, when executed by the one or more processors, further cause the computer system to: determine and rank the plurality of input request boxes and the plurality of chat boxes based on context data.

Example 17. The computer system of example 14, wherein the initial input comprises one or more of: (i) an alphanumeric string, (ii) a file, (iii) image data, or (iv) audio data.

Example 18. The computer system of example 14, wherein the instructions, when executed by the one or more processors, further cause the computer system to: generate a diagnostics report indicating one or more of: (i) a set of frequently determined intents, (ii) time values associated with a chat, or (iii) a set of frequently used sets of input requests.

Example 19. The computer system of example 18, wherein the diagnostics report is accessible only to a set of users with particular permissions.

Example 20. A tangible, non-transitory computer-readable medium storing executable instructions for improving prompt engineering, the instructions, when executed by one or more processors of a computer system, cause the computer system to: receive an initial input from a user; determine an intent corresponding to the initial input; provide a set of input requests to the user based on the intent or the initial input; receive one or more subsequent inputs from the user in response to the set of input requests; apply a prompt generation engine to (i) the intent, (ii) the initial input, and (iii) the one or more subsequent inputs to output an input prompt; transmit the input prompt to a machine learning model that is configured to output a response to the input prompt; and cause the response to be displayed for viewing by the user.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A computer-implemented method for improved prompt engineering, comprising:
receiving, by one or more processors, an initial input from a user;
determining, by the one or more processors, an intent corresponding to the initial input;
providing, by the one or more processors, a set of input requests to the user based on the intent or the initial input;
receiving, by the one or more processors, one or more subsequent inputs from the user in response to the set of input requests;
applying, by the one or more processors, a prompt generation engine to (i) the intent, (ii) the initial input, and (iii) the one or more subsequent inputs to output an input prompt;
transmitting, by the one or more processors, the input prompt to a machine learning model that is configured to output a response to the input prompt; and
causing, by the one or more processors, the response to be displayed for viewing by the user.

2. The computer-implemented method of claim 1, further comprising:
transmitting, by the one or more processors, (i) the initial input, and (ii) a request to an input request creation engine configured to generate the set of input requests;
applying the input request creation engine to the initial input and the request to generate the set of input requests; and
receiving, by the one or more processors, the set of input requests.

3. The computer-implemented method of claim 2, further comprising:
applying the input request creation engine to (i) the initial input, (ii) the request, and (iii) the intent to output the set of input requests, wherein the input request creation engine is trained with a plurality of training intents and a plurality of training inputs to output a plurality of training sets of input requests.

4. The computer-implemented method of claim 1, further comprising:
transmitting, by the one or more processors, (i) the initial input, and (ii) a request to the machine learning model configured to generate the set of input requests, wherein the machine learning model generates the set of input requests; and
receiving, by the one or more processors, the set of input requests from the machine learning model.

5. The computer-implemented method of claim 1, wherein the one or more processors further determine the intent based on (i) the initial input and (ii) context data indicating a user conversation history and a set of user background information.

6. The computer-implemented method of claim 5, wherein the set of input requests to the user is further based on the context data.

7. The computer-implemented method of claim 6, wherein the one or more processors further apply the prompt generation engine to (i) the intent, (ii) the initial input, (iii) the one or more subsequent inputs, and (iv) the context data to output the input prompt.

8. The computer-implemented method of claim 5, wherein the set of user background information includes one or more of (i) a tone consistency value, (ii) a performance indicator value, and (iii) a mission statement.

9. The computer-implemented method of claim 5, wherein the context data comprises a plurality of context relevancy levels, including: (i) an entity level, (ii) a group level, (iii) an enterprise level, and (iv) a public level.

10. The computer-implemented method of claim 9, wherein the prompt generation engine further outputs the input prompt by:
determining that a first level of the plurality of context relevancy levels fails to satisfy a context threshold; and
incorporating additional context data from the context data by adjusting from the first level of the plurality of context relevancy levels to a second level of the plurality of context relevancy levels, wherein the second level is at least one of: (i) the group level, (ii) the enterprise level, or (iii) the public level.

11. The computer-implemented method of claim 1, wherein the machine learning model is from an approved service of a plurality of approved services.

12. The computer-implemented method of claim 11, wherein each approved service of the plurality of approved services comprises: (i) a respective machine learning model, (ii) a respective API schema indicating a respective input prompt type, and (iii) a data processing schema indicating a respective input prompt format.

13. The computer-implemented method of claim 12, wherein the one or more processors applies the prompt generation engine to (i) the intent, (ii) the initial input, (iii) the one or more subsequent inputs, (iv) the respective API schema indicating a respective input prompt type, and (v) the data processing schema indicating a respective input prompt format.

14. A computer system for improving prompt engineering comprising:
one or more processors; and
a non-transitory program memory coupled to the one or more processors and storing executable instructions that, when executed by the one or more processors, causes the computer system to:
receive an initial input from a user;
determine an intent corresponding to the initial input;
provide a set of input requests to the user based on the intent or the initial input;
receive one or more subsequent inputs from the user in response to the set of input requests;
apply a prompt generation engine to (i) the intent, (ii) the initial input, and (iii) the one or more subsequent inputs to output an input prompt;
transmit the input prompt to a machine learning model that is configured to output a response to the input prompt; and
cause the response to be displayed for viewing by the user.

15. The computer system of claim 14, wherein the instructions, when executed by the one or more processors, further cause the computer system to:
provide a user interface to the user that comprises a plurality of input request boxes and a plurality of chat boxes, wherein each input request box of the plurality of input request boxes correlates to a respective set of input requests, wherein each chat box of the plurality of chat boxes is a respective chat instance of the user, and wherein each chat instance has a respective chat context.

16. The computer system of claim 15, wherein the instructions, when executed by the one or more processors, further cause the computer system to:
determine and rank the plurality of input request boxes and the plurality of chat boxes based on context data.

17. The computer system of claim 14, wherein the initial input comprises one or more of: (i) an alphanumeric string, (ii) a file, (iii) image data, or (iv) audio data.

18. The computer system of claim 14, wherein the instructions, when executed by the one or more processors, further cause the computer system to:
generate a diagnostics report indicating one or more of: (i) a set of frequently determined intents, (ii) time values associated with a chat, or (iii) a set of frequently used sets of input requests.

19. The computer system of claim 18, wherein the diagnostics report is accessible only to a set of users with particular permissions.

20. A tangible, non-transitory computer-readable medium storing executable instructions for improving prompt engineering, the instructions, when executed by one or more processors of a computer system, cause the computer system to:
receive an initial input from a user;
determine an intent corresponding to the initial input;
provide a set of input requests to the user based on the intent or the initial input;
receive one or more subsequent inputs from the user in response to the set of input requests;
apply a prompt generation engine to (i) the intent, (ii) the initial input, and (iii) the one or more subsequent inputs to output an input prompt;
transmit the input prompt to a machine learning model that is configured to output a response to the input prompt; and
cause the response to be displayed for viewing by the user.
